(19) United States
(12) Patent Application Publication
(10) Pub. No.: US 2016/0016096 A1
(43) Pub. Date: Jan. 21, 2016

(54) UNIVERSAL TRANSLATOR FOR AN AUTOMATION AND MOTION CONTROL SYSTEM

(71) Applicant: TAIT TOWERS MANUFACTURING, LLC, Lititz, PA (US)

(72) Inventors: Scott FISHER, Las Vegas, NV (US); James D. LOVE, Lititz, PA (US); Christopher Schlicht WESSELS, Las Vegas, NV (US)

(21) Appl. No.: 14/772,528

(22) PCT Filed: Mar. 10, 2014
(86) PCT No.: PCT/US2014/022737

§ 371 Date: Sep. 3, 2015

Related U.S. Application Data
(60) Provisional application No. 61/777,287, filed on Mar. 12, 2013.

(51) Int. Cl. A63J 99/00; G05B 19/042

(52) U.S. Cl. CPC A63J 99/00; G05B 19/0421; G05B 2219/25204; G05B 2219/2664

(57) ABSTRACT

A universal translator for an automation and motion control system enables components from different manufacturers to communicate with each other and be controlled by the automation and motion control system. The universal translator can remove unnecessary information from the component to enhance operation of the automation and motion control system.

### CROSS-REFERENCE TO RELATED APPLICATION

This application claims the benefit of U.S. Provisional Application No. 61/777,287 filed Mar. 12, 2013, which is hereby incorporated by reference in its entirety.

### BACKGROUND

The application generally relates to an automation and motion control system for the entertainment industry. The application relates more specifically to a universal translator for an automation and motion control system that enables components of the automation and motion control system utilizing different communication protocols to communicate with each other and with automation and motion control system.

In the entertainment industry, to provide a realistic atmosphere for a theatrical production, theatrical objects or components can be moved or controlled by an automation and motion control system during (and between) scenes on a stage or takes on a motion picture production set. Automation of the movement and control of the theatrical objects or components is desirable for safety, predictability, efficiency, and economics. For proper utilization of the automation and motion control system, all components under the control of the automation and control system have to be able to communicate with each other. One way to ensure that all the components can communicate with each other is to select components that all use the same communication protocol. One disadvantage to using the same communication protocol is that the best component for the task to be performed may not use the appropriate communication protocol and thus, that component is excluded from use in the system in favor of a component that uses the proper communication protocol. Similarly, there may not be an available component that uses the proper communication protocol, thereby precluding that functionality from the system. Another disadvantage is that the requirement for interoperability of all components can limit the communication speed and effectiveness between components because a less robust communication protocol may have to be selected for interoperability of all the components.

Therefore, what is needed is a universal translator for an automation and motion control system that can convert information from any system component to a common protocol that enables the component to communicate with and be controlled by the automation and motion control system.

### SUMMARY

The present application is directed to an automation and motion control system to control a plurality of theatrical objects. The control system includes a plurality of nodes in communication with each other over a real time network using a preselected protocol. Each node of the plurality of nodes corresponds to at least one item of equipment used to a control a theatrical object. Each node of the plurality of nodes includes a microprocessor and memory. Each node of the plurality of nodes includes a translator connected to the at least one item of equipment. The at least one item of equipment sends and receives at least one of data, signals, information or control instructions. The translator is operable to convert data, signals, information or control instructions in an equipment protocol used by the at least one item of equipment to data, signals, information or control instructions in the preselected protocol and to convert data, signals, information or control instructions in the preselected protocol to data, signals, information or control instructions in the equipment protocol used by the at least one item of equipment.

The present application is also directed to a computer implemented method of translating information between protocols in an automation and motion control system. The method includes receiving, at an input connection, inputs from a source. The received inputs include at least one of data, signals, information or control instructions in a first protocol. The method further includes determining whether all of the received inputs are required for a second protocol and disregarding any unnecessary received inputs in response to a determination that not all of the received inputs are required for the second protocol. The method also includes converting the remaining received inputs into the second protocol and providing, at an output connection, outputs to a destination, the outputs corresponding to the converted inputs in the second protocol. The destination understands and uses the provided inputs to complete a control function.

One advantage of the present application is the capability for real time operation and/or implementation of motion control systems, safety systems, I/O devices, show control functions, industrial protocols, DMX systems, SMPTE systems, VITC systems, and 3D environment constructions and controls from different manufacturers.

Another advantage of the present application is that the control system has a structural organization that permits any type of device to be built while maintaining the same operational paradigm, thereby enabling all devices to exchange information.

Other features and advantages of the present application will be apparent from the following more detailed description of the preferred embodiment, taken in conjunction with the accompanying drawings which illustrate, by way of example, the principles of the application.

### BRIEF DESCRIPTION OF THE DRAWINGS

FIG. 1 schematically shows an exemplary embodiment of an automation and motion control system.

FIG. 2 schematically shows an alternate embodiment of an automation and motion control system.

FIG. 3 schematically shows an exemplary embodiment of a connection between a component and a node.

FIG. 4 schematically shows an exemplary embodiment of connections between several components and a node.

FIG. 5 shows an exemplary embodiment of a process of translating between communication protocols.

Wherever possible, the same reference numbers are used throughout the drawings to refer to the same or like parts.

### DETAILED DESCRIPTION OF THE EXEMPLARY EMBODIMENTS

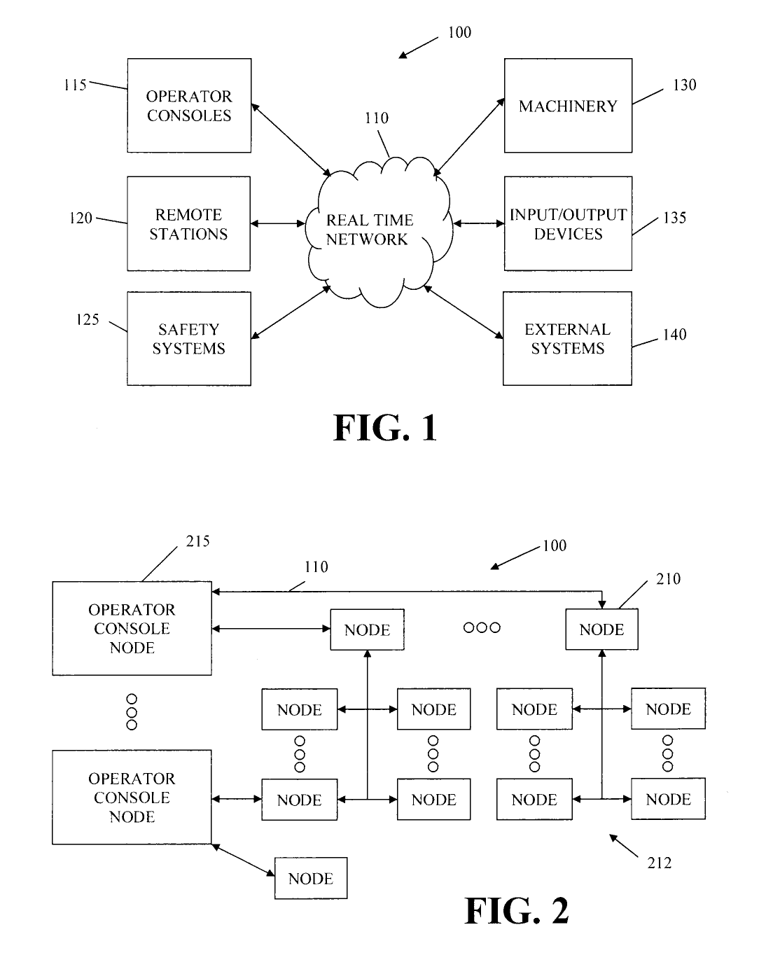

FIG. 1 shows an exemplary embodiment of the automation and motion control system of the present application. The automation and control system 100 can include a real time network 110, interconnecting operator consoles 115, remote stations 120, safety systems 125, machinery 130, input/output devices 135 and external systems 140. In one exemplary embodiment, safety systems 125 can include emergency stop (e-stop) systems; machinery 130 can include lifts, chain hoists, winches, elevators, carousels, turntables, hydraulic systems, pneumatic systems, multi-axis systems, linear motion systems (e.g., deck tracks and line sets), audio devices, lighting devices, and/or video devices; input/output devices 135 can include incremental encoders, absolute encoders, variable voltage feedback devices, resistance feedback devices, tachometers and/or load cells; and external systems 140 can include show control systems, industrial protocols and third party software interfaces including 0-10 V (volt) systems, Modbus or Modbus TCP systems, Profibus systems, ArtNet systems, BMS (Building Management System) systems, EtherCAT® systems, DMX systems, SMPTE (Society of Motion Picture and Television Engineers) systems, VITC systems, MIDI (Musical Instrument Digital Interface) systems, MANET (Mobile Ad hoc NETwork) systems, K-Bus systems, Serial systems (including RS 485 and RS 232), Ethernet systems, Open Source Controls (OSC), TCP/IP (Transmission Control Protocol/Internet Protocol) systems, UDP (User Datagram Protocol) systems, ControlNet systems, DeviceNet systems, RS 232 systems, RS 45 systems, CAN bus (Controller Area Network bus) systems, Maya systems, Lightwave systems, Catalyst systems, 3ds Max or 3D Studio Max systems, and/or a custom designed system.

FIG. 2 shows an alternate embodiment of the automation and motion control system. The automation and motion control system 100 shown in FIG. 2 can be formed from the interconnection of logical nodes 210. Each node 210 can be associated with a specific component or device (or group of devices) from remote stations 120, safety systems 125, machinery 130, input/output devices 135 and external systems 140. An operator console node 215 can be associated with a specific device from operator consoles 115 and can enable an operator to interact with the control system 100, i.e., to send data and instructions to the control system 100 and to receive data and information from the control system 100. The operator console node 215 is similar to the other nodes 210 except that the operator console node 215 can include a graphical user interface (GUI) or human-machine interface (HMI) to enable the operator to interact with the control system 100. In one exemplary embodiment, the operator console node 215 can be a Windows® computer.

In an exemplary embodiment, the operator(s) can make inputs into the control system 100 at operator console nodes 215 using one or more input devices, e.g., a pointing device such as a mouse, a keyboard, a panel of buttons, or other similar devices. As shown in FIG. 2, nodes 210 and operator console nodes 215 are interconnected with each other. Thus, any node 210, 215 can communicate, i.e., send and receive data and/or instructions, with any other node 210, 215 in the control system 100. In one exemplary embodiment, a group of nodes 210 can be arranged or configured into a network 212 that interconnects the nodes 210 in the group and provides a reduced number of connections with the other nodes 210, 215. In another exemplary embodiment, nodes 210, 215 and/or node networks 212 can be interconnected in a star, daisy chain, ring, mesh, daisy chain loop, token ring, or token star arrangement or in combinations of those arrangements. In a further exemplary embodiment, the control system 100 can be formed from more or less nodes 210, 215 and/or node networks 212 than those shown in FIG. 2.

In one exemplary embodiment, each node 210, 215 can be independently operated and self-aware, and can also be aware of at least one other node 210, 215. In other words, each node 210, 215 can be aware that at least one other node 210, 215 is active or inactive (e.g., online or offline).

In another exemplary embodiment, each node 210, 215 is independently operated using decentralized processing, thereby allowing the control system 100 to remain operational even if a node 210, 215 may fail because the other operational nodes 210, 215 still have access to the operational data of the nodes 210, 215. Each node 210, 215 can be a current connection into the control system 100, and can have multiple socket connections into the network 110, each providing node communications into the control system 100 through the corresponding node 210, 215. As such, as each individual node 210, 215 is taken “offline,” the remaining nodes 210, 215 can continue operating and load share. In a further exemplary embodiment, the control system 100 can provide the operational data for each node 210, 215 to every other node 210, 215 all the time, regardless of how each node 210, 215 is related to each other node 210, 215.

The communication between nodes 210, 215 can use a preselected communication protocol that enable the nodes 210, 215 to understand and share information, data and control instructions among the nodes 210, 215. Some examples of the communication protocol that can be used between nodes 210, 215 include EtherCAT®, TCP/IP, UDP, Modbus, Modbus TCP, CAN, ArtNet, OSC or DMX. To enable communication between a node 210, 215 and its corresponding connected device(s) or component(s), the automation and motion control system 100 can use a universal translator at each node 210, 215, as required, to convert or interpret the information, data and instructions associated with the component or device into the preselected communication protocol used by the nodes 210, 215 and the automation and motion control system 100. The universal translator enables two-way communication between the node 210, 215 and the component or device regardless of the communication protocol used by the component or device.

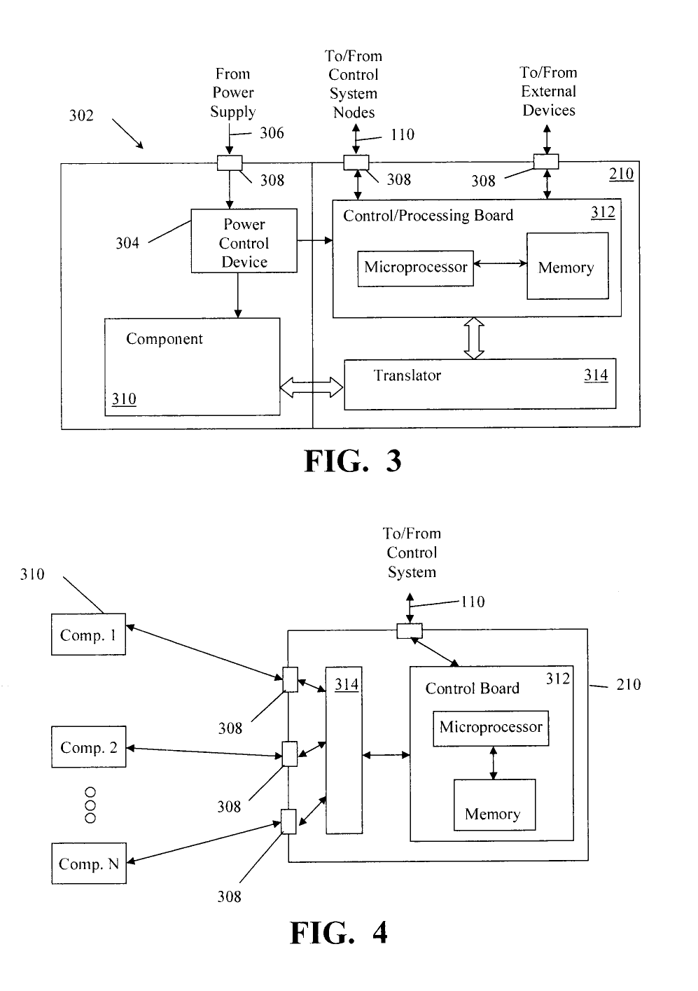

FIGS. 3 and 4 schematically show exemplary embodiments of the connections between the component(s) and a node. FIG. 3 shows a connection between a component and a node sharing a common housing. FIG. 4 shows a connection between several external components and a single node. In other embodiments, multiple components and/or nodes can be located in a common housing or a single external component can be connected to one or more nodes.

In FIG. 3, a housing 302 can include both a node 210 and a component or device 310 that is controlled by the node 210. The component or device 310 can be any suitable type of device that can fit, or partially fit, within housing 302 such as a winch, lift, elevator, carousel, turntable, hydraulic system, pneumatic system, multi-axis system, linear motion system (e.g., deck tracks and line sets), audio device, lighting device, video device, input/output device or chain hoist. A power control device 304 can be included in the housing 302. The power control device 304 can receive power from power lines 306 through an interface connection 308 and provide power to the device 310, the node 210 and any other component in the housing 302 that has a power requirement. In one embodiment, the power control device 304 can include one or more transformers. The node 210 can include an interface connection 308 through the housing 302 to provide input and/or output connections to the network 110 and the other nodes 210 and an interface connection 308 through the housing 302 for other external devices, such as portable memory devices (e.g., memory cards or flash drives) or operator interfaces (e.g., joystick, keyboard, mouse or monitor).

The node 210 includes a control/processing board or device 312. The control/processing board 312 can provide the primary control functions for the node 210 and can execute one or more control programs or processes to control operation of the component 310 and/or to share information, data and control instructions with other nodes and/or external devices. The control/processing board 312 can include one or more microprocessors and one or more memory devices. In one embodiment, the control/processing board 312 can exchange, i.e., send and receive, data, signals, instructions and/or information with the other nodes 210 connected to the network 110 and/or any connected external devices.

In one exemplary embodiment, the microprocessor(s) of the control/processing board 312 can execute one or more control programs or algorithms stored in the memory device(s) associated with the component 310. The control program or algorithm executed by the control/processing board 312 can provide the necessary control instructions to control operation of the component 310. For example, the control/processing board 312 can provide instructions or commands to control operation of the component 310, to turn on outputs, to send analog signals, to monitor incoming signals or inputs and/or to trigger audio commands. In addition, the control/processing board 312 can receive signals, instructions and/or information from the control system 100 and/or the other nodes 210, 215 and then can generate the appropriate response instructions or commands for the component 310 based on the received input. By having information on the operation of the other nodes 210, 215, the control/processing board 312 can generate the appropriate instructions or commands for the component 310 to provide for smooth operation of the system.

In one exemplary embodiment, the control algorithm(s) stored in the control board 312 can be executed in response to receiving a particular command or signal from control system 100. A command or signal from control system 100 could trigger the execution of a control algorithm in the control board 312 that would result in several individual actions being taken by the component 310. For example, a sequence of actions taken by the component 310 in response to a signal from the control system 100 could be to coordinate with other nodes 210, 215 after a predetermined time period.

A translator 314 is used by the node 210 to convert, interpret and/or translate data, signals, information and/or control instructions from the component 310 into the preselected communication protocol used by the node 210. The translator 314 may include an interface, such as wiring terminals or a plug receptacle, to enable a physical connection with the component 310 to send and receive the data, signals, information and/or control instructions. The translator 314 may also include a microprocessor and memory device to complete the conversion process. In another embodiment, the translator 314 may be in wireless communication with the component 310 to send and receive the data, signals, information and/or control instructions. The translator 314 can convert, interpret and/or translate the data, signals, information and/or control instructions from the device into data, signals, information and control instructions formatted in the preselected communication protocol and understood by the control board 312. The control board 312 can then transmit the converted data, signals, information and/or control instructions over the network 110 using the preselected communication protocol to other nodes 210, 215 in the control system 100. The translator 314 can also translate, interpret and/or convert data, signals, information and/or control instructions formatted in the preselected communication protocol from the control board 312 into the corresponding communication protocol for the component 310 to enable proper control and operation of the component 310.

The component 310 can use any available communication protocol or technique and communicate with the translator 314. The component 310 may provide the translator 314 with one or more voltages, currents, formatted digital inputs or other signals over one or more wires. The inputs to the translator 314 can correspond to sensor measurements, operational statuses, commands, warnings, errors or other component related information. The translator 314 takes the voltages, currents and/or formatted digital inputs from the component 310 and converts them into a format appropriate for the preselected communication protocol. The conversion of the data, signals, information and/or control instructions by the translator 314 (either from the component 310 to the control board 312 or from the control board 312 to the component 310) can use any suitable technique including look-up tables and/or conversion equations. In the look-up table each possible input value or set of associated values has a corresponding output value. There can be one look-up table that can be used for conversions in either direction, i.e., component to control board or control board to component. Alternatively, a different look-up table can be used for each direction of conversion, e.g., one table for component to control board conversions and a second table for control board to component conversions.

In the process of completing the conversion, the translator 314 may disregard data, signals, information and/or control instructions from the source (either the component 310 or the control board 312) that is not required or used by the destination (the other of the control board 312 or the component 310) or its corresponding communication protocol. Similarly, the translator 314 may supplement the data, signals, information and/or control instructions from the source to enable compatibility and comprehension by the destination. In other words, the translator 314 can provide data, signals, information and/or control instructions to ensure compliance with the destination communication protocol. By removing unnecessary (by the nodes 210, 215 or control system 100) data, signals, information and/or control instructions from the transmission by the component 310, the translator can improve the speed and efficiency of the control system 100 and network 110 by not translating or transmitting information that is not required by the control system 100.

In one exemplary embodiment, the component 310 can include one or more sensors to measure operating conditions or parameters of the component 310. Some examples of operating conditions or parameters that can be measured can include temperature, current, load or weight (load cell), angle, g-force or acceleration (accelerometer), direction of movement, or speed of movement. The sensors can then transmit the measured operational data to the translator 314 and then the control/processing board 312. The control/processing board 312 may then use some, all or none of this information during the execution of the control program and algorithm to determine and/or generate the appropriate commands. The operating conditions or parameters of the component that are not needed or required by the control system can be filtered out or removed by the translator 314. In one embodiment, the control/processing board 312 can also transmit the sensor data to the other nodes 210, 215 and/or the control system 100 to be used by the control programs or algorithms of the other nodes 210, 215 and/or the control system 100.

In FIG. 4, the components 310 are located separate from the node 210 and connected to the node 210 at interface connections 308. The interface connections 308 can be any suitable type of connection point that can permit the transfer of the data, signals, information and/or control instructions from the component 310 to the translator 314. The interface connection 308 can include one or more wire terminals or plug receptacles. The translator 314 can process the sets or packets of data, signals, information and/or control instructions from each of the components and then send the converted data, signals, information and/or control instructions to the control board 312 for subsequent processing or handling. The translator 314 can also receive data, signals, information and/or control instructions from the control board 312 and convert the data, signals, information and/or control instructions into the proper format to be understood by the appropriate component. In another embodiment, instead of a single translator handling the data, signals, information and/or control instructions from multiple interfaces, each interface can have its own corresponding translator that communicates with the control board 312.

In another exemplary embodiment, the translator 314 can be integrated into or part of the control board 312. The translator 314 can be a software module executed by the microprocessor to complete the conversion of the data, signals, information and/or control instructions. Alternatively, the translator 314 can be incorporated as one or more hardware components on the control board 312.

In one exemplary embodiment, the translator 314 can manage all of the management tasks for each protocol. For example, in TCP/IP when a message is received, an additional message is sent to the sender to confirm that the data was received. The sending of the confirmation is not data that is relevant to the system, but is required to maintain functionality.

In a further exemplary embodiment, the translator 314 can automatically determine the communication protocol used by a component 310 when the component 310 is connected to the translator 314. Once the translator determines the communication protocol being used by the component 310, the translator 314 can then apply the appropriate conversions to enable the component 310 to communicate with the control board 312 and node 210. In one embodiment, the translator 314 can determine the communication protocol of the component 310 based on the data, signals, information and/or control instructions provided or input by the component 310 to the translator 314. If the data, signals, information and/or control instructions provided by the component match several different communication protocols, the translator can execute one or more test algorithms to determine which communication protocol is being used by the component. In other embodiments, the communication protocol can “announce” its presence and introduce itself to the translator 314 or the communication protocol can be discovered by the translator 314 through a “listening” process.

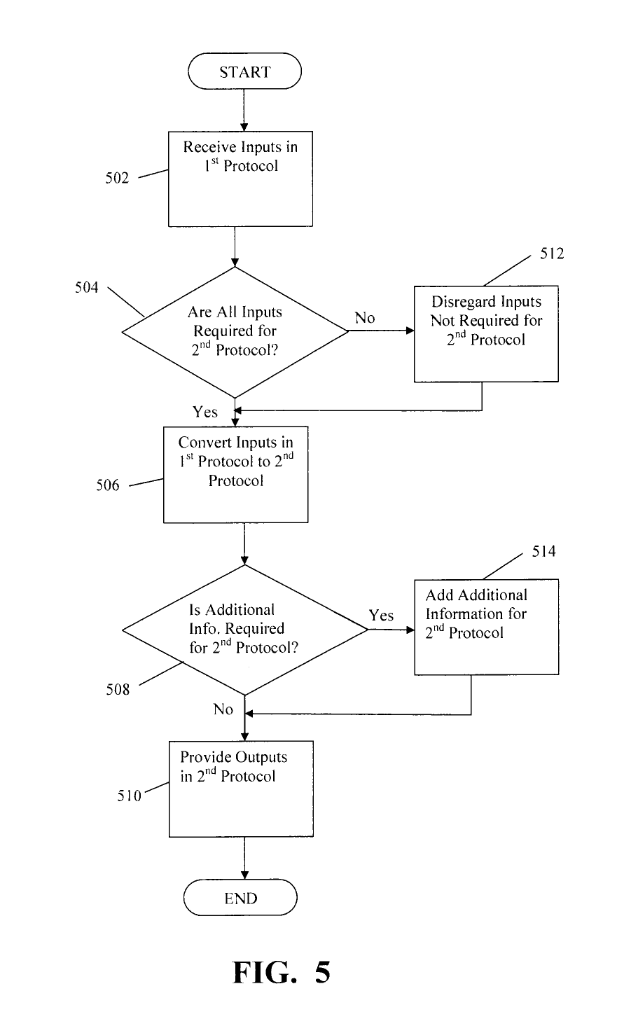

An exemplary embodiment of a translation process is shown in FIG. 5. The process begins by receiving into the translator 314 the inputs from the source in the first communication protocol (step 502). The inputs can be from either the component 310 or the control board 312 and can include one or more of data, signals, information and/or control instructions. Next, a determination is made as to whether all of the inputs in the first communication protocol are required for the second communication protocol (step 504). If all of the inputs are required for the second communication protocol the inputs are converted to the second communication protocol (step 506). If some inputs are not required for the second communication protocol, then those inputs are disregarded by the translator 314 (step 512) and the remaining inputs are converted to the second communication protocol (step 506). The conversion of the inputs from the first communication protocol to the second communication protocol can be done by look-up table, conversion equation or any other suitable conversion technique. The converted inputs (now in the second communication protocol) are reviewed to determine if all required information has provided for the second communication protocol (step 508). If all of the required information has been provided, then the outputs in the second communication protocol are provided to the destination (step 510). If not all of the required information has been provided, the translator 314 supplements the outputs with the necessary information (step 514) to comply with the second communication protocol and then the supplemented outputs are then provided to the destination (step 510). The destination can be either the component 310 or the control board 312 depending on which device was the source of the inputs.

In an exemplary embodiment, each node can include a computing device such as a process controller, a thin client, a palm top computer, single board computer (SBC), programmable logic controller (PLC), field programmable gate array (FPGA) device or a microprocessor, or the node can be a software device like a “player” or a “virtual machine” which is not a tangible piece of machinery capable of being held in one's hand but is instead a software construct that is considered by the control system to be a device. The software device can supply commands and receive back a status, yet doesn't exist as a physical device. In an exemplary embodiment, each node, whether a computing device or a software device, can execute the QNX real time operating system.

In one exemplary embodiment, the data for all nodes or devices, including data relating to the processes for the node or device, can be made universally available to every other node or device on the network all the time, so that every node or device is aware of the other nodes or devices. With regard to the transfer of data, there are no processor boundaries, and data is not deemed to reside on separate processors. If one node or device is controlled so as to care whether or not another node or device is going too fast, the corresponding data can be known by the node or device because all nodes or devices are constantly trading information via information packets (e.g., IP protocol packets) containing one or more data vectors. In one embodiment, the data can be stored, and made available to all the nodes, in a markup language format (e.g., eXtensible Markup Language—XML).

In another exemplary embodiment, nodes can share data with all the other nodes on the network using a redundant, load sharing, real time network that can reroute data traffic around damaged sections and alert operators to problems on the network. Each node is capable of storing all of the information the node requires to perform its role. Nodes can communicate with each other their current status (position, movement status, direction, velocity, health of the node, how long has it been in service (length of service), how much has it been used (amount of use)). When one node has a problem, the other nodes can know about the problem immediately and can be programmed on how to react to the problem/failure.

The present application contemplates methods, systems and program products on any machine-readable media for accomplishing its operations. The embodiments of the present application may be implemented using an existing computer processor, or by a special purpose computer processor for an appropriate system, or by a hardwired system.

Embodiments within the scope of the present application include program products comprising machine-readable media for carrying or having machine-executable instructions or data structures stored thereon. Machine-readable media can be any available non-transitory media that can be accessed by a general purpose or special purpose computer or other machine with a processor. By way of example, machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machine to perform a certain function or group of functions. Software implementations could be accomplished with standard programming techniques with rule based logic and other logic to accomplish the various connection steps, processing steps, comparison steps and decision steps.

While the exemplary embodiments illustrated in the figures and described herein are presently preferred, it should be understood that these embodiments are offered by way of example only. Other substitutions, modifications, changes and omissions may be made in the design, operating conditions and arrangement of the exemplary embodiments without departing from the scope of the present application. Accordingly, the present application is not limited to a particular embodiment, but extends to various modifications that nevertheless fall within the scope of the appended claims. It should also be understood that the phraseology and terminology employed herein is for the purpose of description only and should not be regarded as limiting.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. An automation and motion control system to control a plurality of theatrical objects, the control system comprising:
a plurality of nodes in communication with each other over a real time network using a preselected protocol, each node of the plurality of nodes corresponds to at least one item of equipment used to a control a theatrical object;
each node of the plurality of nodes comprising a microprocessor and memory;
each node of the plurality of nodes comprising a translator connected to the at least one item of equipment, the at least one item of equipment sending and receiving at least one of data, signals, information or control instructions; and
the translator being operable to convert data, signals, information or control instructions in an equipment protocol used by the at least one item of equipment to data, signals, information or control instructions in the preselected protocol and to convert data, signals, information or control instructions in the preselected protocol to data, signals, information or control instructions in an equipment protocol used by the at least one item of equipment.

2. The automation and motion control system of claim 1 wherein the node and the at least one item of equipment share a housing.

3. The automation and motion control system of claim 1 wherein the translator comprises a processor and at least one memory device.

4. The automation and motion control system of claim 3 wherein the translator comprises at least one look-up table stored in the at least one memory device, the at least one look-up table being used to convert data, signals, information or control instructions between the preselected protocol and the equipment protocol.

5. The automation and motion control system of claim 1 wherein the microprocessor and memory for the node are located on a control board.

6. The automation and motion control system of claim 5 wherein the translator is located on the control board and uses the microprocessor and memory to convert data, signals, information or control instructions between the preselected protocol and the equipment protocol.

7. The automation and motion control system of claim 1 wherein the at least one item of equipment comprises a plurality of items of equipment and the translator converts data, signals, information or control instructions for each item of equipment of the plurality of items of equipment.

8. The automation and motion control system of claim 7 wherein the translator comprises a plurality of translators and each translator of the plurality of translators is associated with a corresponding item of equipment of the plurality of items of equipment.

9. The automation and motion control system of claim 1 wherein the translator automatically detects the equipment protocol based on the data, signals, information or control instructions provided to the translator by the at least one item of equipment.

10. The automation and motion control system of claim 1 wherein the at least one of data, signals, information or control instructions comprise at least one of voltages, currents or digital inputs.

11. The automation and motion control system of claim 1 wherein the equipment protocol contains at least one of data, signals, information or control instructions that is unused by the preselected protocol and the translator disregards the unused data, signals, information or control instructions when converting the data, signals, information or control instructions in the equipment protocol to the data, signals, information or control instructions in the preselected protocol.

12. The automation and motion control system of claim 1 wherein the preselected protocol requires at least one of data, signals, information or control instructions that is unavailable in the equipment protocol and the translator provides the unavailable data, signals, information or control instructions when converting the data, signals, information or control instructions in the equipment protocol to the data, signals, information or control instructions in the preselected protocol.

13. A computer implemented method of translating information between protocols in an automation and motion control system, the method comprising:
receiving, at an input connection, inputs from a source, the received inputs comprising at least one of data, signals, information or control instructions in a first protocol;
determining whether all of the received inputs are required for a second protocol;
disregarding any unnecessary received inputs in response to a determination that not all of the received inputs are required for the second protocol;
converting the remaining received inputs into the second protocol;
providing, at an output connection, outputs to a destination, the outputs corresponding to the converted inputs in the second protocol; and
wherein the destination understands and uses the provided inputs to complete a control function.

14. The computer implemented method of claim 13 wherein the at least one of data, signals, information or control instructions comprise at least one of voltages, currents or digital inputs.

15. The computer implemented method of claim 13 wherein said converting the remaining received inputs comprises using at least one of a look-up table or a conversion equation to complete the conversion to the second protocol.

16. The computer implemented method of claim 13 wherein the source is a component connected to the automation and motion control system and the destination is a node of the automation and motion control system.

17. The computer implemented method of claim 16 wherein the second protocol is used for communication in the automation and motion control system.

18. The computer implemented method of claim 13 wherein the source is a node of the automation and motion control system and the destination is a component connected to the automation and motion control system.

19. The computer implemented method of claim 13 further comprising:
determining whether any additional information is required for the second protocol; and
adding the additional information to the converted remaining received inputs in response to a determination that additional information is required.

20. The computer implemented method of claim 13 further comprising automatically determining the first protocol based on the inputs at the input connection.
